(19) United States
(12) Patent Application Publication
(10) Pub. No.: US 2023/0280994 A1
(43) Pub. Date: Sep. 7, 2023

(54) INFORMATION PROCESSING DEVICE AND INSTALLATION SUPPORT METHOD

(71) Applicant: Fujitsu Limited, Kawasaki-shi (JP)

(72) Inventor: Shade RUANGWAN, Kawasaki (JP)

(73) Assignee: Fujitsu Limited, Kawasaki-shi (JP)

(21) Appl. No.: 18/088,808

(22) Filed: Dec. 27, 2022

(30) Foreign Application Priority Data
Mar. 4, 2022 (JP) 2022-033512

(51) Int. Cl. G06F 8/61; G06F 8/36

(52) U.S. Cl. CPC G06F 8/61; G06F 8/36

(57) ABSTRACT

A non-transitory computer-readable recording medium stores a program for causing a computer to execute a process that includes adding identification information of each of a plurality of libraries to be installed, to a determination target list one by one, performing, every time the identification information of each of the plurality of libraries is added to the determination target list, a determination process that determines compatibility between a plurality of determination target libraries that include first libraries indicated by first identification information included in the determination target list and depended libraries on which the first libraries depend, when incompatibility regarding a second library indicated by the added identification information is detected, deleting the added identification information from the determination target list, and when the incompatibility regarding the second library is not detected, generating a library list that contains the first identification information and identification information of the depended libraries.

### CROSS-REFERENCE TO RELATED APPLICATION

This application is based upon and claims the benefit of priority of the prior Japanese Patent Application No. 2022-33512, filed on Mar. 4, 2022, the entire contents of which are incorporated herein by reference.

### FIELD

The embodiment discussed herein is related to an information processing device and an installation support method.

### BACKGROUND

Pip Installs Packages (pip) are used when installing a Python library from Python Package Index (PyPI) to an information processing device (computer). The library contains a plurality of programs that are modularized so as to be allowed to be used when called from other programs. Each program included in the library has a particular function.

PyPI is a repository corresponding to the ecosystem of the Python library, and pip is a package installer that installs a software package from PyPI or the like. A user may install the library by giving pip a library name, a GitHub link, or a requirements file containing a list of library names.

In relation to software installation, a system that facilitates runtime generation that recognizes container compliance is known.

Japanese National Publication of International Patent Application No. 2020-527798 is disclosed as related art.

### SUMMARY

According to an aspect of the embodiment, a non-transitory computer-readable recording medium stores a program for causing a computer to execute a process, the process includes adding identification information of each of a plurality of libraries to be installed, to a determination target list one by one, performing, every time the identification information of each of the plurality of libraries is added to the determination target list, a determination process that determines compatibility between a plurality of determination target libraries that include first libraries indicated by first identification information included in the determination target list and depended libraries on which the first libraries depend, when incompatibility regarding a second library indicated by the added identification information is detected in the determination process, deleting the added identification information from the determination target list, when the incompatibility regarding the second library is not detected in the determination process, generating a library list that contains the first identification information and identification information of the depended libraries, and outputting the library list after the determination process for the plurality of libraries is completed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of an installation support device;

FIG. 2 is a diagram illustrating a configuration of an installation system;

FIG. 3 is a diagram illustrating a functional configuration of an information processing device;

FIG. 4 is a diagram illustrating a determination target list;

FIG. 5 is a flowchart of an installation support process;

FIG. 6 is a diagram illustrating an initial library list;

FIG. 7 is a diagram illustrating a first example of requirements.in;

FIG. 8 is a diagram illustrating a first example of requirements.txt;

FIG. 9 is a diagram illustrating a first example of an additional library list;

FIG. 10 is a diagram illustrating a second example of requirements.in;

FIG. 11 is a diagram illustrating an execution log;

FIG. 12 is a diagram illustrating a third example of requirements.in;

FIG. 13 is a diagram illustrating a second example of requirements.txt;

FIG. 14 is a diagram illustrating a second example of the additional library list;

FIG. 15 is a diagram illustrating a pseudocode; and

FIG. 16 is a diagram illustrating a hardware configuration of the information processing device.

### DESCRIPTION OF EMBODIMENT

When a plurality of libraries are installed at once using pip, the latest versions of those libraries are downloaded first. At this time, version conflicts sometimes occur due to dependencies between the libraries.

For example, when a library A and a library B to be installed depend on different versions of a library C, a version conflict occurs. The fact that a library X depends on a library Y means that the library Y is used to build or execute the library X. In the following, a library depended on, such as the library Y, will be sometimes described as a depended library.

When a version conflict occurs between the latest versions of libraries, pip will download an older version of each library. Then, pip checks the compatibility of the older version with versions of other libraries and attempts to resolve the version conflict on a best-effort basis. When a combination of versions that does not cause any version conflict between the libraries is found, those versions are compatible with each other. In this case, the version conflict is resolved.

However, as the number of libraries to be installed increases, the likelihood of the occurrence of more version conflicts rises. For this reason, more computational resources are consumed and longer time is taken to designate a combination of compatible versions for all the libraries. For example, when a requirements file containing hundreds of libraries is given, it sometimes takes hours to resolve version conflicts. In addition, an unresolved version conflict is ignored, which leads to a runtime error in some cases.

Note that such a problem is not limited to the case of installing Python libraries but arises when installing libraries written in various programming languages.

Hereinafter, an embodiment will be described in detail with reference to the drawings.

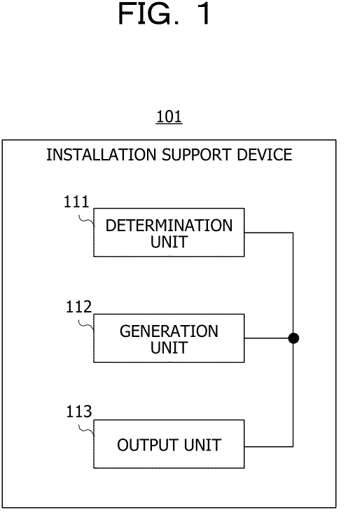

FIG. 1 illustrates a functional configuration example of an installation support device according to the embodiment. An installation support device 101 in FIG. 1 includes a determination unit 111, a generation unit 112, and an output unit 113. The determination unit 111 adds identification information of each of a plurality of libraries to be installed, to a determination target list one by one. Then, the determination unit 111 performs a determination process for determining compatibility between a plurality of determination target libraries every time the identification information of each of the plurality of libraries is added to the determination target list.

The plurality of determination target libraries includes a library indicated by the identification information included in the determination target list and a depended library on which a library indicated by the identification information included in the determination target list depends.

When incompatibility regarding the library indicated by the added identification information is detected in the determination process, the generation unit 112 deletes the added identification information from the determination target list. When incompatibility regarding the library indicated by the added identification information is not detected in the determination process, the generation unit 112 generates a library list including the identification information included in the determination target list and the identification information of the depended libraries.

The output unit 113 outputs the library list after the determination process for the plurality of libraries is completed.

According to the installation support device 101 in FIG. 1, an installation process for a plurality of libraries may be speeded up.

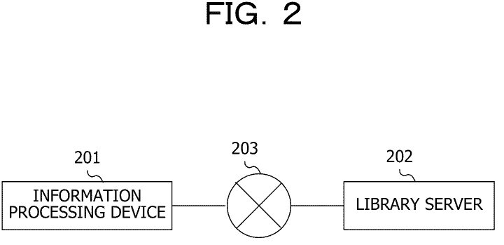

FIG. 2 illustrates a configuration example of an installation system including the installation support device 101 in FIG. 1. The installation system in FIG. 2 includes an information processing device 201 and a library server 202. The information processing device 201 corresponds to the installation support device 101 in FIG. 1.

The information processing device 201 communicates with the library server 202 via a communication network 203. The communication network 203 is, for example, a wide area network (WAN) or a local area network (LAN).

The library server 202 stores a plurality of libraries. The information processing device 201 transmits, to the library server 202, a request demanding a library to be installed, receives the library from the library server 202, and installs the received library in the information processing device 201. When the library to be installed is for Python, the plurality of libraries stored by the library server 202 correspond to PyPI.

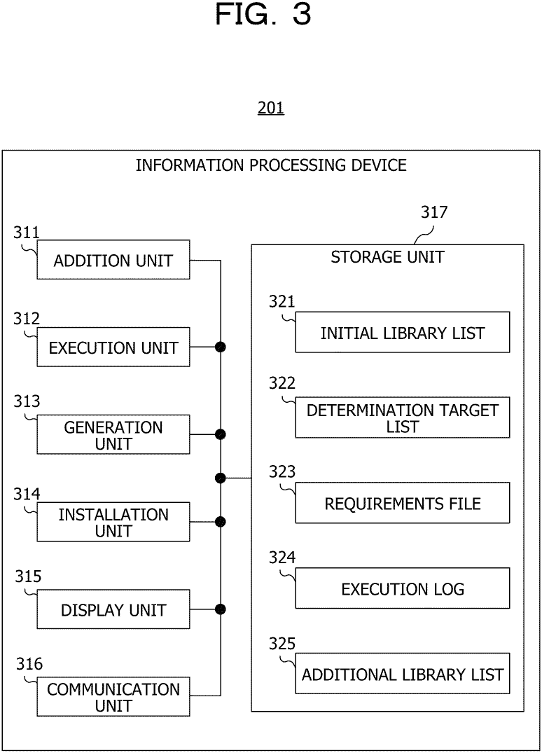

FIG. 3 illustrates a functional configuration example of the information processing device 201 in FIG. 2. The information processing device 201 in FIG. 3 includes an addition unit 311, an execution unit 312, a generation unit 313, an installation unit 314, a display unit 315, a communication unit 316, and a storage unit 317. The addition unit 311 and the execution unit 312 correspond to the determination unit 111 in FIG. 1, the generation unit 313 corresponds to the generation unit 112 in FIG. 1, and the display unit 315 or the communication unit 316 corresponds to the output unit 113 in FIG. 1.

The storage unit 317 stores an initial library list 321, a determination target list 322, a requirements file 323, an execution log 324, and an additional library list 325.

The initial library list 321 contains names of a plurality of libraries to be installed, which have been specified by the user. A name of a library corresponds to an identification information of the library. In the following, the name of the library will be sometimes described as a library name.

The library name of the library to be determined is added to the determination target list 322 by the addition unit 311. The requirements file 323 and the execution log 324 are generated by the execution unit 312.

The library names included in the requirements file 323 are added to the additional library list 325 by the generation unit 313. The additional library list 325 corresponds to a library list including the identification information included in the determination target list and the identification information of the depended libraries.

When the library to be installed is for Python, the determination target list 322 corresponds to, for example, requirements.in that is an input file of pip-compile, and the requirements file 323 corresponds to, for example, requirements.txt that is an output file of pip-compile.

Above-mentioned pip-compile is a pip command. The command pip-compile generates requirements.txt from the dependencies between libraries specified by the input file, which is setup.py or requirements.in. Above-mentioned requirements.txt contains each library name included in requirements.in and library names of depended libraries on which each library depends.

The depended libraries include depended libraries in direct dependency and depended libraries in transitive dependency. The direct dependency represents that a certain library directly depends on a depended library. The transitive dependency represents that a certain library indirectly depends on a depended library via another library.

When a version compatible with other libraries is not detected for some libraries among the libraries indicated by each library name included in requirements.in and the depended libraries of these libraries, pip-compile outputs an error message. When an error message is output, the execution of pip-compile is interrupted. In this case, normally, resolution of the version conflict is manually attempted.

Library developers sometimes use pip-compile to publish requirements for their developed libraries. However, pip-compile does not have the function to install the libraries.

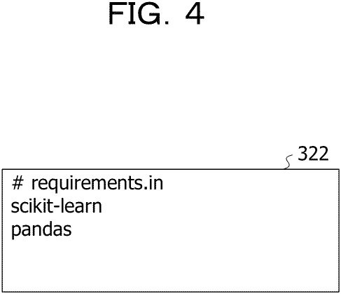

FIG. 4 illustrates an example of the determination target list 322. The determination target list 322 in FIG. 4 is requirements.in and contains two library names, namely, scikit-learn and pandas.

The addition unit 311 adds the library names included in the initial library list 321 to the determination target list 322 one by one. Every time the library name is added to the determination target list 322, the execution unit 312 performs the determination process for determining compatibility between a plurality of determination target libraries to generate the requirements file 323 and the execution log 324. Then, the execution unit 312 saves the requirements file 323 and the execution log 324 in the storage unit 317.

The plurality of determination target libraries includes libraries indicated by each library name included in the determination target list 322 and depended libraries on which these libraries depend. The requirements file 323 contains each library name included in the determination target list 322, the library names of the depended libraries on which each library depends, and version information indicating versions of these libraries. The versions indicated by the version information included in the requirements file 323 are compatible with each other. The requirements file 323 is an example of requirement information.

When the determination target list 322 is requirements.in, the execution unit 312 performs the determination process by executing pip-compile and generates requirements.txt and the execution log 324 from the determination target list 322. In this case, the generated requirements.txt corresponds to the requirements file 323.

Among the plurality of determination target libraries, the library indicated by the library name added to the determination target list 322 or the depended library of that library sometimes does not have a version compatible with other determination target libraries. In this case, the execution unit 312 determines that incompatibility regarding the library indicated by the added library name has been detected and generates the execution log 324 containing an error message.

The execution unit 312 may detect incompatibility regarding the library indicated by the added library name, by checking whether or not there is a combination of compatible versions for all the determination target libraries in the determination process.

When all the determination target libraries have versions compatible with other determination target libraries, the execution unit 312 determines that no incompatibility regarding the library indicated by the added library name has been detected. Then, the execution unit 312 generates the execution log 324 that does not contain an error message.

When the execution log 324 does not contain an error message, the generation unit 313 adds the library names that are not included in the additional library list 325 among the library names included in the requirements file 323 to the additional library list 325. Consequently, all the library names included in the additional library list 325 and all the library names included in the requirements file 323 match.

On the other hand, when the execution log 324 contains an error message, the generation unit 313 deletes the added library name from the determination target list 322. In this case, the deleted library name will not be added to the additional library list 325.

When all the library names included in the initial library list 321 are added to the determination target list 322 and the determination process for the last added library name is completed, the display unit 315 displays the additional library list 325 on a screen. This allows the user to confirm the depended libraries of the libraries indicated by the library names included in the initial library list 321 and also to confirm whether or not there is a library name deleted from the initial library list 321.

The communication unit 316 communicates with the library server 202. The installation unit 314 designates the libraries indicated by each of the plurality of library names included in the finally generated additional library list 325, as the libraries to be installed. Then, the installation unit 314 transmits a request demanding the libraries to be installed, to the library server 202 via the communication unit 316.

The communication unit 316 receives the libraries to be installed, from the library server 202, and the installation unit 314 installs the received libraries.

When the requirements file 323 is requirements.txt, the installation unit 314 downloads the libraries to be installed, from the library server 202, by executing pip using the requirements file 323 as an input file. Since mutually compatible versions are specified for all the libraries included in the requirements file 323, the probability of successful installation by pip rises.

Instead of the display unit 315 displaying the additional library list 325, the communication unit 316 may transmit the additional library list 325 to a user terminal device (not illustrated). In this case, the user terminal device displays the received additional library list 325 on a screen.

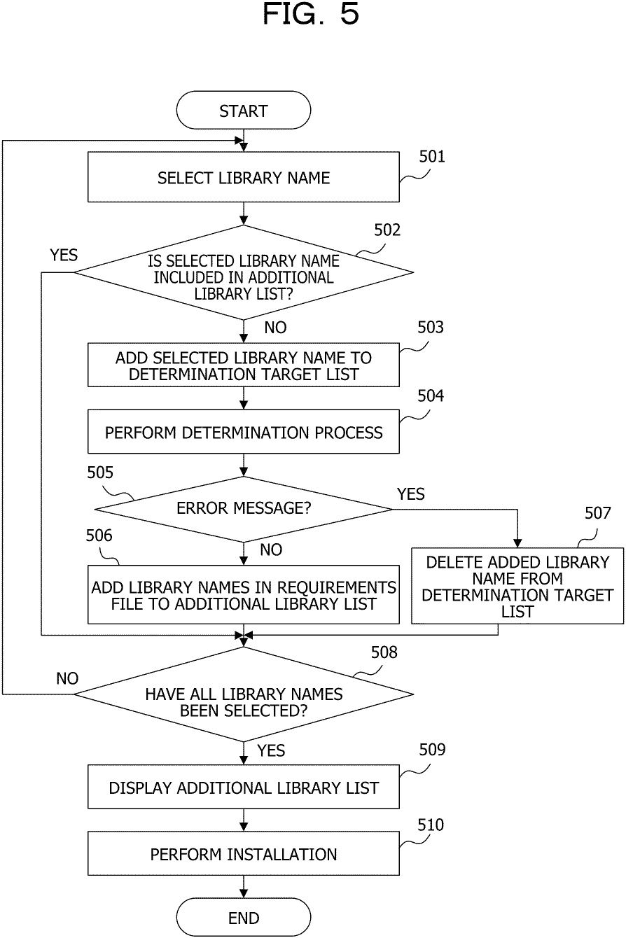

FIG. 5 is a flowchart illustrating an example of an installation support process performed by the information processing device 201 in FIG. 3. First, the addition unit 311 selects any library name from the initial library list 321 (step 501) and checks whether or not the selected library name is included in the additional library list 325 (step 502).

When the selected library name is not included in the additional library list 325 (step 502, NO), the addition unit 311 adds the selected library name to requirements.in, which is the determination target list 322 (step 503).

Next, the execution unit 312 performs the determination process by executing pip-compile with requirements.in as an input file (step 504). Then, the execution unit 312 generates requirements.txt, which is the requirements file 323, and the execution log 324.

Next, the generation unit 313 checks whether or not the execution log 324 contains an error message (step 505). When the execution log 324 does not contain an error message (step 505, NO), the generation unit 313 updates the additional library list 325 (step 506). In step 506, the generation unit 313 adds the library names that are not included in the additional library list 325 among the library names included in the requirements file 323 to the additional library list 325.

On the other hand, when the execution log 324 contains an error message (step 505, YES), the generation unit 313 deletes the library name added to the determination target list 322 in step 503 from the determination target list 322 (step 507).

Next, the addition unit 311 checks whether or not all the library names included in the initial library list 321 have been selected (step 508). When an unselected library name remains (step 508, NO), the information processing device 201 repeats the processes from step 501 onwards for the next library name.

When the selected library name is included in the additional library list 325 (step 502, YES), the information processing device 201 performs the processes from step 508 onwards.

When all the library names have been selected (step 508, YES), the display unit 315 displays the additional library list 325 on the screen (step 509). The user confirms the displayed additional library list 325 and inputs an installation instruction to the information processing device 201 if there is no problem.

The installation unit 314 executes pip using the requirements file 323 as an input file in accordance with the input installation instruction. This causes the installation unit 314 to download the libraries indicated by each of the plurality of library names included in the additional library list 325, from the library server 202, and install the downloaded libraries (step 510).

According to the installation support process in FIG. 5, when an error occurs in the determination process, the library that is the cause of the error is deleted from requirements.in and the process continues. Therefore, the verification of compatibility between libraries may be performed without interruption.

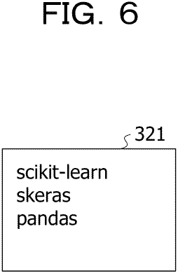

Next, a specific example of the installation support process will be described with reference to FIGS. 6 to 14.

FIG. 6 illustrates an example of the initial library list 321. The initial library list 321 in FIG. 6 contains three library names, namely, scikit-learn, skeras, and pandas. First, the addition unit 311 selects scikit-learn from the initial library list 321 in FIG. 6 and adds selected scikit-learn to requirements.in.

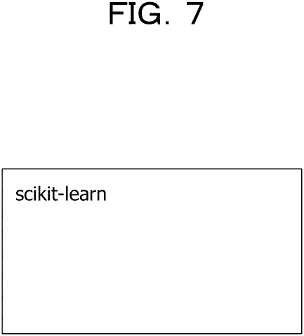

FIG. 7 illustrates a first example of requirements.in. In FIG. 7, requirements.in contains selected scikit-learn. The execution unit 312 generates requirements.txt and the execution log 324 by executing pip-compile using requirements.in in FIG. 7.

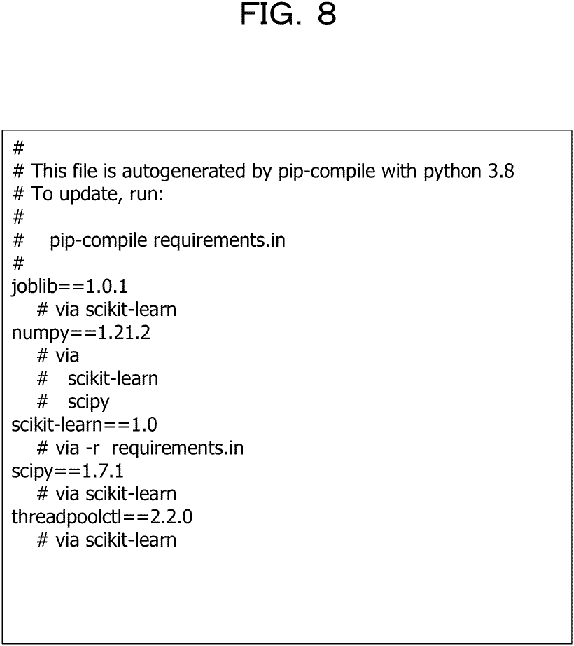

FIG. 8 illustrates a first example of requirements.txt. In FIG. 8, requirements.txt is generated from requirements.in in FIG. 7 and contains five library names, namely, joblib, numpy, scikit-learn, scipy, and threadpoolctl, and version information of these libraries.

The library name scikit-learn denotes the library included in requirements.in. The library names joblib, scipy, and threadpoolctl denote depended libraries in direct dependency on which scikit-learn depends. The library name numpy denotes a depended library in direct dependency on which scikit-learn and scipy depend. Accordingly, numpy is also a depended library in transitive dependency on which scikit-learn depends via scipy.

The version of joblib is “1.0.1”, the version of numpy is “1.21.2”, and the version of scikit-learn is “1.0”. The version of scipy is “1.7.1”, and the version of threadpoolctl is “2.2.0”.

The execution log 324 generated from requirements.in in FIG. 7 contains information similar to the information in requirements.txt in FIG. 8 and does not contain an error message. Thus, the generation unit 313 adds the library names included in requirements.txt in FIG. 8 to the additional library list 325.

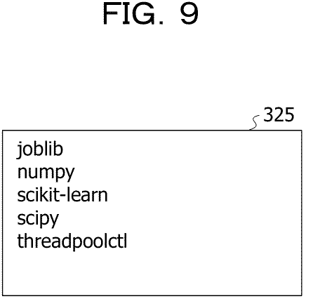

FIG. 9 illustrates a first example of the additional library list 325. The additional library list 325 in FIG. 9 contains the five library names included in requirements.txt in FIG. 8.

Next, the addition unit 311 selects skeras from the initial library list 321 in FIG. 6 to add selected skeras to requirements.in in FIG. 7.

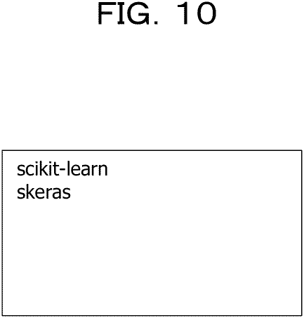

FIG. 10 illustrates a second example of requirements.in. In FIG. 10, requirements.in contains selected skeras. The execution unit 312 generates requirements.txt and the execution log 324 by executing pip-compile using requirements.in in FIG. 10. At this time, generated requirements.txt contains information similar to the information in requirements.txt in FIG. 8.

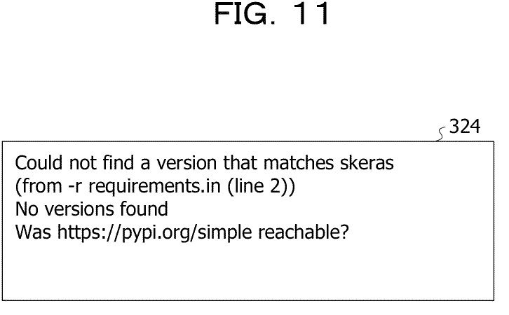

FIG. 11 illustrates an example of the execution log 324. The execution log 324 in FIG. 11 contains an error message indicating that there is no version of skeras added to requirements.in that is compatible with other determination target libraries.

In this case, since the execution log 324 contains an error message, the generation unit 313 deletes added skeras from requirements.in in FIG. 10. Consequently, requirements.in returns to the state in FIG. 7, and the additional library list 325 is not updated. In addition, generated requirements.txt does not contain information on added skeras and its depended libraries.

Next, the addition unit 311 selects pandas from the initial library list 321 in FIG. 6 to add selected pandas to requirements.in in FIG. 7.

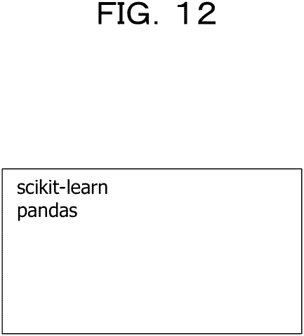

FIG. 12 illustrates a third example of requirements.in. In FIG. 12, requirements.in contains selected pandas. The execution unit 312 generates requirements.txt and the execution log 324 by executing pip-compile using requirements.in in FIG. 12.

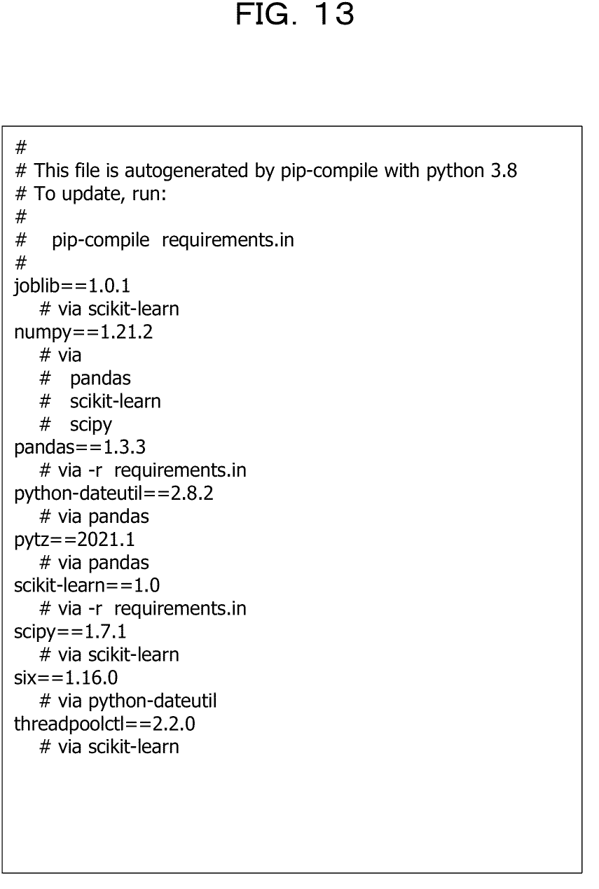

FIG. 13 illustrates a second example of requirements.txt. In FIG. 13, requirements.txt is generated from requirements.in in FIG. 12. In FIG. 13, requirements.txt contains nine library names, namely, joblib, numpy, pandas, python-dateutil, pytz, scikit-learn, scipy, six, and threadpoolctl. In FIG. 13, requirements.txt further contains version information of these libraries.

The library names scikit-learn and pandas denote the libraries included in requirements.in. The library names joblib, scipy, and threadpoolctl denote depended libraries in direct dependency on which scikit-learn depends. The library name numpy denotes a depended library in direct dependency on which pandas, scikit-learn, and scipy depend on. Accordingly, numpy is also a depended library in transitive dependency on which scikit-learn depends via scipy.

The library names python-dateutil and pytz denote depended libraries in direct dependency on which pandas depends. The library name six denotes a depended library in direct dependency on which python-dateutil depends. Accordingly, six is also a depended library in transitive dependency on which pandas depends via python-dateutil.

The version of joblib is “1.0.1”, the version of numpy is “1.21.2”, and the version of pandas is “1.3.3”. The version of python-dateutil is “2.8.2”, and the version of pytz is “2021.1”. The version of scikit-learn is “1.0”, and the version of scipy is “1.7.1”. The version of six is “1.16.0”, and the version of threadpoolctl is “2.2.0”.

The execution log 324 generated from requirements.in in FIG. 12 contains information similar to the information in requirements.txt in FIG. 13 and does not contain an error message. Thus, the generation unit 313 adds the library names that are not included in the additional library list 325 in FIG. 9 among the library names included in requirements.txt in FIG. 13 to the additional library list 325.

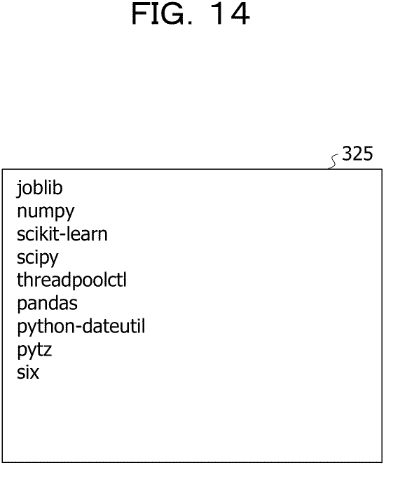

FIG. 14 illustrates a second example of the additional library list 325. The additional library list 325 in FIG. 14 contains the nine library names included in requirements.txt in FIG. 13. At this point, all the library names included in the initial library list 321 in FIG. 6 have been selected, and therefore, the display unit 315 displays the additional library list 325 in FIG. 14 on the screen.

This allows the user to confirm that joblib, numpy, python-dateutil, pytz, scipy, six, and threadpoolctl, which were not included in the initial library list 321, are depended libraries. Furthermore, the user may confirm that skeras has been deleted from the initial library list 321.

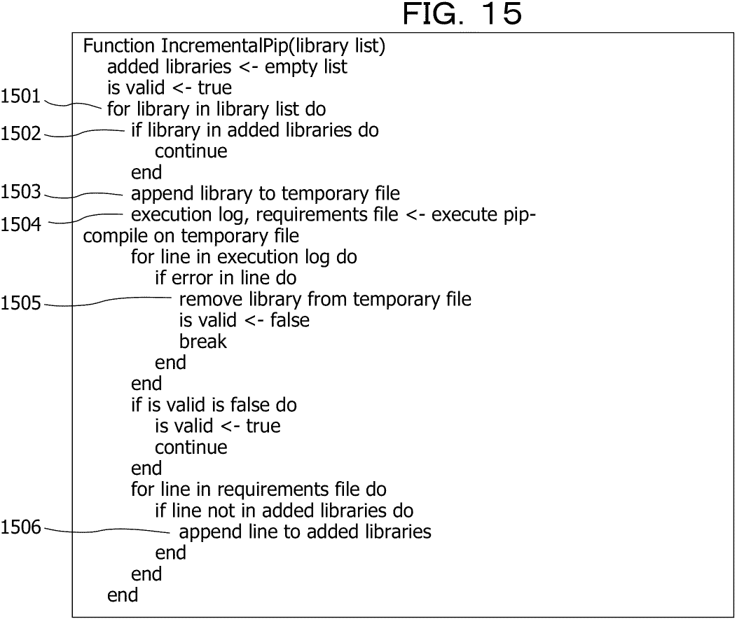

FIG. 15 illustrates an example of pseudocode for executing the installation support process in FIG. 5. In a statement 1501, “library list” corresponds to the initial library list 321, in a statement 1502, “added libraries” corresponds to the additional library list 325, and in a statement 1503, “temporary file” corresponds to requirements.in. In a statement 1504, “execution log” and “requirements file” correspond to the execution log 324 and requirements.txt, respectively.

The statement 1504 corresponds to the process in step 504, the statement 1505 corresponds to the process in step 507, and the statement 1506 corresponds to the process in step 506.

According to the information processing device 201 in FIG. 3, compatibility between the versions of the libraries is verified using pip-compile before installing the libraries to be installed. Therefore, the user is allowed to install the libraries by pip using the requirements file containing version information that has been verified for compatibility.

Since the compatibility between the versions of the libraries is already verified, the compatibility verification during the execution of pip is completed in a short time, and the installation time is shortened. Accordingly, the installation process for a plurality of libraries is speeded up, and the waiting time of the user is reduced.

According to experimental results, when the requirements file contains 175 libraries, a traditional installation process takes more than two hours. In contrast to this, in the information processing device 201 in FIG. 3, the time taken to generate the requirements file is 17 minutes, and the time taken for the installation process by pip using the generated requirements file is seven minutes. Accordingly, generating the requirements file and executing pip together takes only 24 minutes. In this case, an installation time of over two hours is shortened to less than 30 minutes.

The configuration of the installation support device 101 in FIG. 1 is merely an example, and some components may be omitted or modified according to the use or conditions of the installation support device 101. The configuration of the installation system in FIG. 2 is merely an example, and some components may be omitted or modified according to the use or conditions of the installation system.

The configuration of the information processing device 201 in FIG. 3 is merely an example, and some components may be omitted or modified according to the use or conditions of the information processing device 201. For example, when the installation process is performed by an external device, the installation unit 314 may be omitted.

The flowchart in FIG. 5 is merely an example, and some processes may be omitted or modified according to the configuration or conditions of the information processing device 201. For example, when the installation process is performed by an external device, the process in step 510 may be omitted.

The initial library list 321 illustrated in FIG. 6 is merely an example, and the initial library list 321 changes according to the libraries to be installed. The library to be installed may be a library written in another programming language such as JavaScript (registered trademark).

The input files requirements.in illustrated in FIGS. 7, 10, and 12 are merely examples, and requirements.in changes according to the initial library list 321. The output files requirements.txt illustrated in FIGS. 8 and 13 and the additional library lists 325 illustrated in FIGS. 9 and 14 are only examples, and requirements.txt and the additional library list 325 change according to requirements.in.

The error message illustrated in FIG. 11 is only an example, and other forms of error messages may be used. The pseudocode illustrated in FIG. 15 is merely an example, and other forms of pseudocode may be used.

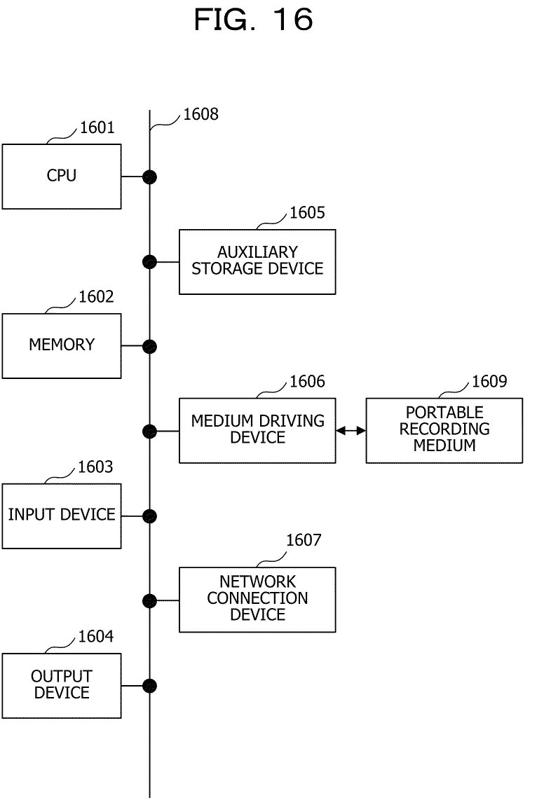

FIG. 16 illustrates a hardware configuration example of an information processing device to be used as the installation support device 101 in FIG. 1 and the information processing device 201 in FIG. 3. The information processing device in FIG. 16 includes a central processing unit (CPU) 1601, a memory 1602, an input device 1603, an output device 1604, an auxiliary storage device 1605, a medium driving device 1606, and a network connection device 1607. These components are hardware and are coupled to each other by a bus 1608.

The memory 1602 is, for example, a semiconductor memory such as a read only memory (ROM) or a random access memory (RAM) and stores programs and data to be used for processes. The memory 1602 may operate as the storage unit 317 in FIG. 3.

The CPU 1601 (processor) operates as the determination unit 111 and the generation unit 112 in FIG. 1 by, for example, executing a program using the memory 1602. The CPU 1601 also operates as the addition unit 311, the execution unit 312, the generation unit 313, and the installation unit 314 in FIG. 3 by executing a program using the memory 1602.

For example, the input device 1603 is a keyboard, a pointing device, or the like and is used for inputting instructions or information from a user or an operator. For example, the output device 1604 is a display device, a printer, or the like and is used for an inquiry or an instruction to the user or the operator, and an output of a processing result. The processing result may be the requirements file 323, the execution log 324, or the additional library list 325. The output device 1604 may operate as the output unit 113 in FIG. 1 or the display unit 315 in FIG. 3.

For example, the auxiliary storage device 1605 is a magnetic disk device, an optical disk device, a magneto-optical disk device, a tape device, or the like. The auxiliary storage device 1605 may be a hard disk drive. The information processing device may save programs and data in the auxiliary storage device 1605 and load these programs and data into the memory 1602 to use. The auxiliary storage device 1605 may operate as the storage unit 317 in FIG. 3.

The medium driving device 1606 drives a portable recording medium 1609 and accesses the recorded contents of the portable recording medium 1609. The portable recording medium 1609 is a memory device, a flexible disk, an optical disk, a magneto-optical disk, or the like. The portable recording medium 1609 may be a compact disk read only memory (CD-ROM), a digital versatile disk (DVD), a universal serial bus (USB) memory, or the like. The user or the operator may save the programs and data in the portable recording medium 1609 and load these programs and data into the memory 1602 to use.

As described above, a computer-readable recording medium in which the programs and data used for processes are saved is a physical (non-transitory) recording medium such as the memory 1602, the auxiliary storage device 1605, and the portable recording medium 1609.

The network connection device 1607 is a communication interface circuit that is connected to the communication network 203 and performs data conversion associated with communication. The information processing device may receive programs and data from an external device via the network connection device 1607 and load these programs and data into the memory 1602 to use. The network connection device 1607 may operate as the output unit 113 in FIG. 1 or the communication unit 316 in FIG. 3.

Note that the information processing device does not have to include all the components in FIG. 16, and some components may be omitted according to the use or conditions of the information processing device. For example, when an interface with the user or the operator is not desired, the input device 1603 and the output device 1604 may be omitted. When the portable recording medium 1609 is not used, the medium driving device 1606 may be omitted.

As the library server 202 in FIG. 2, an information processing device similar to the information processing device in FIG. 16 may be used.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
adding identification information of each of a plurality of libraries to be installed, to a determination target list one by one;
performing, every time the identification information of each of the plurality of libraries is added to the determination target list, a determination process that determines compatibility between a plurality of determination target libraries that include first libraries indicated by first identification information included in the determination target list and depended libraries on which the first libraries depend;
when incompatibility regarding a second library indicated by the added identification information is detected in the determination process, deleting the added identification information from the determination target list;
when the incompatibility regarding the second library is not detected in the determination process, generating a library list that contains the first identification information and identification information of the depended libraries; and
outputting the library list after the determination process for the plurality of libraries is completed.

2. The non-transitory computer-readable recording medium according to claim 1, the process further comprising:
determining that the incompatibility regarding the second library has been detected, when one of the second library and depended libraries on which the second library depends does not have a version compatible with other libraries among the plurality of determination target libraries.

3. The non-transitory computer-readable recording medium according to claim 1, the process further comprising:
installing libraries indicated by the identification information included in the library list.

4. The non-transitory computer-readable recording medium according to claim 3, the process further comprising:
generating requirement information that includes the first identification information, first version information that indicates versions of the first libraries, second identification information of the depended libraries, and second version information that indicates versions of the depended libraries; and
installing the libraries indicated by the identification information included in the library list by using the requirement information, wherein
versions indicated by the version information included in the requirement information are compatible with each other.

5. An information processing device, comprising:
a memory: and
a processor coupled to the memory and the processor configured to:
add identification information of each of a plurality of libraries to be installed, to a determination target list one by one;
perform, every time the identification information of each of the plurality of libraries is added to the determination target list, a determination process that determines compatibility between a plurality of determination target libraries that include first libraries indicated by first identification information included in the determination target list and depended libraries on which the first libraries depend;
when incompatibility regarding a second library indicated by the added identification information is detected in the determination process, delete the added identification information from the determination target list;
when the incompatibility regarding the second library is not detected in the determination process, generate a library list that contains the first identification information and identification information of the depended libraries; and
output the library list after the determination process for the plurality of libraries is completed.

6. The information processing device according to claim 5, wherein
the processor is further configured to:
determine that the incompatibility regarding the second library has been detected, when one of the second library and depended libraries on which the second library depends does not have a version compatible with other libraries among the plurality of determination target libraries.

7. The information processing device according to claim 5, wherein
the processor is further configured to:
install libraries indicated by the identification information included in the library list.

8. The information processing device according to claim 7, wherein
the processor is further configured to:
generate requirement information that includes the first identification information, first version information that indicates versions of the first libraries, second identification information of the depended libraries, and second version information that indicates versions of the depended libraries; and
install the libraries indicated by the identification information included in the library list by using the requirement information,
wherein
versions indicated by the version information included in the requirement information are compatible with each other.

9. An installation support method, comprising:
adding, by a computer, identification information of each of a plurality of libraries to be installed, to a determination target list one by one;
performing, every time the identification information of each of the plurality of libraries is added to the determination target list, a determination process that determines compatibility between a plurality of determination target libraries that include first libraries indicated by first identification information included in the determination target list and depended libraries on which the first libraries depend;
when incompatibility regarding a second library indicated by the added identification information is detected in the determination process, deleting the added identification information from the determination target list;
when the incompatibility regarding the second library is not detected in the determination process, generating a library list that contains the first identification information and identification information of the depended libraries; and
outputting the library list after the determination process for the plurality of libraries is completed.

10. The installation support method according to claim 9, the process further comprising:
determining that the incompatibility regarding the second library has been detected, when one of the second library and depended libraries on which the second library depends does not have a version compatible with other libraries among the plurality of determination target libraries.

11. The installation support method according to claim 9, the process further comprising:
installing libraries indicated by the identification information included in the library list.

12. The installation support method according to claim 11, the process further comprising:
generating requirement information that includes the first identification information, first version information that indicates versions of the first libraries, second identification information of the depended libraries, and second version information that indicates versions of the depended libraries; and
installing the libraries indicated by the identification information included in the library list by using the requirement information, wherein
versions indicated by the version information included in the requirement information are compatible with each other.
